(19) United States
(12) Patent Application Publication
(10) Pub. No.: US 2005/0124395 A1
(43) Pub. Date: Jun. 9, 2005

(54) Portable communication apparatus and method thereof

(76) Inventors: Dong-Won Bae, Dacgu (KR); Eon-Seog Cheon, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/934,494

(22) Filed: Sep. 7, 2004

(30) Foreign Application Priority Data
Dec. 6, 2003 (KR) 2003-88390

(51) Int. Cl. H04B 1/03; H04M 1/00

(52) U.S. Cl. 455/575.3; 455/575.4

(57) ABSTRACT

A portable communication apparatus adapted to be extendedly rotated in multiple stages and a method thereof. The apparatus and method comprise a first housing extending along a longitudinal direction; a second housing connected to the first housing by a dual hinge device and adapted to be rotated in multi-stages toward or away from the first housing about first and second hinge axes in a direction perpendicular to the longitudinal direction; a dual hinge device which rotatably connects the first and second housing to each other, provides the first and second hinge axes, and is adapted to rotate the second housing about the first hinge axis, as well as to rotate the second housing about the second hinge axis in such a manner that the second housing extends along the longitudinal direction of the second housing when a button unit, which is exposed to the exterior of the first housing, is pressed; and a hinge locking module positioned in the first housing and the dual hinge device to extendedly rotate or hold the second housing as the button unit is pressed.

### PRIORITY

This application claims the benefit under 35 U.S.C. § 119(a) of an application entitled “Portable Communication Apparatus” filed with the Korean Intellectual Property Office on Dec. 6, 2003 and assigned Serial No. 2003-88390, the entire contents of which are incorporated herein by reference.

### BACKGROUND OF THE INVENTION

1. Field of the Invention

The present invention relates to a portable communication apparatus and method thereof. More particularly, the present invention relates to a portable communication apparatus having housings adapted to be extendedly rotated in multiple stages and a method thereof.

2. Description of the Related Art

The term “portable communication apparatus” typically refers to an apparatus which a user can carry to perform wireless communication with a desired partner. Such portable communication apparatuses include Hand Held Products (HHPs), Cordless Telephony Generation 2 (CT-2) cellular phones, digital phones, Personal Communication System (PCS) phones, and Personal Digital Assistants (PDAs) and may be classified into various categories according to appearance, such as bar-type apparatuses, flip-type apparatuses, and folder-type apparatuses. Bar-type apparatuses have a single housing shaped like a bar. Flip-type portable apparatuses have a flip or a cover which is rotatably mounted to a bar-shaped housing by a hinge device. Folder-type apparatuses have a folder which is connected to a single bar-shaped housing by a hinge device in such a manner that the folder can be rotated in order to be folded to or unfolded from the housing.

Conventional portable communication apparatuses, described above, are equipped with a required antenna device, data input and output devices, as well as data transmission and reception devices. The data input device comprises a key pad, which is used to input data with finger pressing operations. A touch pad or a touch screen may be used instead.

A Liquid Crystal Display (LCD) is generally used for the display function of the data output device.

Recently, the flip-type or folder-type portable communication apparatuses have been widely used, because they have excellent speech sensitivity and it is easy to make the size of their bodies compact and lighter.

The folder-type portable communication apparatus comprises a body on which various key buttons and a microphone device are positioned, a folder on which an LCD display unit and a speaker device are positioned, and a hinge device adapted to mechanically connect the body with the folder and to rotate the folder upward from the body.

During use, the folder is rotated upward a predetermined angle or more from the body.

The folder is adapted to be rotated in a typical range of 0-150° from the body. If the folder is rotated a predetermined angle or more, it is provided with an assistive force and is automatically opened, without any additional application of force from the user. If the folder is rotated about 150°, a hinge module provides a stopping force.

According to current trends, additional functions (such as, transmitting and receiving text messages or video clips) of portable communication apparatuses, in addition to a speech function, have become popular.

However, in the case of a conventional portable communication apparatus, the hinge device cannot rotate the folder more than 150° from the body to open the apparatus, even when it needs to be used as a remote control unit or for other additional functions. The folder can only be rotated up to 150° for speech.

Furthermore, when the user watches a video clip, the folder of the apparatus covers a portion of the screen. Even when the user slants the apparatus to watch the whole screen, the lighting makes it is difficult to watch the screen clearly.

### SUMMARY OF THE INVENTION

Accordingly, the present invention has been made to solve the above-mentioned problems occurring in the prior art, and an object of the present invention is to provide a portable communication apparatus adapted to be extendedly rotated in multiple stages and a method thereof.

Another object of the present invention is to provide a portable communication apparatus capable of being extendedly rotated by a dual hinge device from an angular position for speech, to a fully open position so that it can be used as a remote control unit and for other additional functions in a convenient way and a method thereof.

Still another object of the present invention is to provide a portable communication apparatus capable of being extendedly rotated by a dual hinge device from an angular position for speech, to a fully open position so that it can be used to watch video clips conveniently and a method thereof.

In order to accomplish this object, there is provided a portable communication apparatus and method comprising a first housing extending along a longitudinal direction; a second housing connected to the first housing by a dual hinge device and adapted to be rotated in multi-stages toward or away from the first housing about first and second hinge axes in a direction perpendicular to the longitudinal direction; a dual hinge device which rotatably connects the first and second housing to each other, provides the first and second hinge axes, and is adapted to rotate the second housing about the first hinge axis, as well as to rotate the second housing about the second hinge axis in such a manner that the second housing extends along the longitudinal direction of the second housing when a button unit, which is exposed to the exterior of the first housing, is pressed; and a hinge locking module positioned in the first housing and the dual hinge device to extendedly rotate or hold the second housing as the button unit is pressed.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable communication apparatus according to an embodiment of the present invention wherein its second housing is rotated 150° to be opened from its first housing;

FIG. 2 is a perspective view magnifying part A of FIG. 1;

FIG. 3 is a sectional view showing the construction of a portable communication apparatus according to an embodiment of the present invention;

FIG. 4 is a side sectional view showing the internal construction of a dual hinge device of a portable communication apparatus according to an embodiment of the present invention, before a locking unit is coupled thereto;

FIG. 5 is a side sectional view showing the internal construction of a dual hinge device of a portable communication apparatus according to an embodiment of the present invention, after a locking unit is coupled thereto;

FIG. 6 is perspective view showing a hinge locking module of a portable communication apparatus according to an embodiment of the present invention;

FIG. 7 is a perspective view showing the construction of a portable communication apparatus according to an embodiment of the present invention, wherein a locking unit is coupled to a releasable protrusion of a first center hinge arm;

FIG. 8 is a perspective view showing the construction of a portable communication apparatus according to an embodiment of the present invention, wherein a locking unit is released from a releasable protrusion of a first center hinge arm;

FIG. 9 is a perspective view showing the construction of a portable communication apparatus according to an embodiment of the present invention, wherein a locking unit is released from a releasable protrusion of a first center hinge arm and is rotated;

FIG. 10 is a side sectional view showing the construction of a portable communication apparatus according to an embodiment of the present invention before the operation of a hinge locking module, which is positioned in a dual hinge device;

FIG. 11 is a side sectional view showing the construction of a portable communication apparatus according to an embodiment of the present invention during the operation of a hinge locking module, which is positioned in a dual hinge device;

FIG. 12 is a side sectional view showing the operation of a hinge locking module, which is positioned in a dual hinge device, wherein a second housing is rotated 180° to be opened from a first housing of a portable communication apparatus according to an embodiment of the present invention;

FIG. 13 is a perspective view showing a portable communication apparatus according to an embodiment of the present invention wherein its second housing is rotated 180° to be opened from its first housing;

FIG. 14 is a perspective view magnifying part B of FIG. 13; and

FIG. 15 is a side sectional view showing a portable communication apparatus according to an embodiment of the present invention wherein its second housing is rotated 180° to be opened from its first housing.

Throughout the drawings, it should be noted that the same or similar elements are denoted by like reference numerals.

### DETAILED DESCRIPTION OF THE EXEMPLARY EMBODIMENTS

Exemplary embodiments of the present invention will now be described with reference to the accompanying drawings. In the following description of embodiments of the present invention, a detailed description of known functions and configurations incorporated herein will be omitted for conciseness.

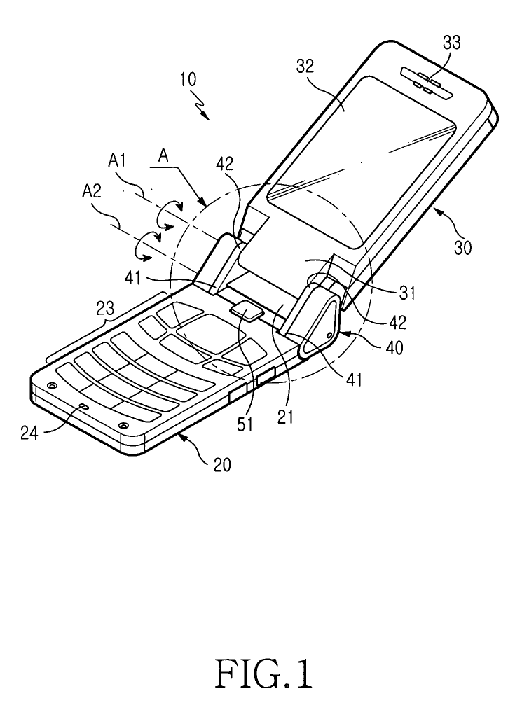

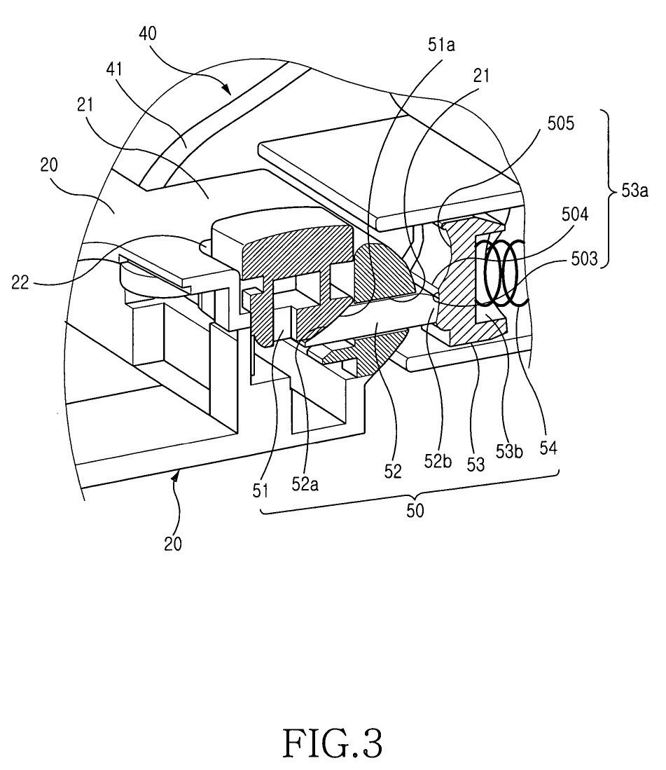

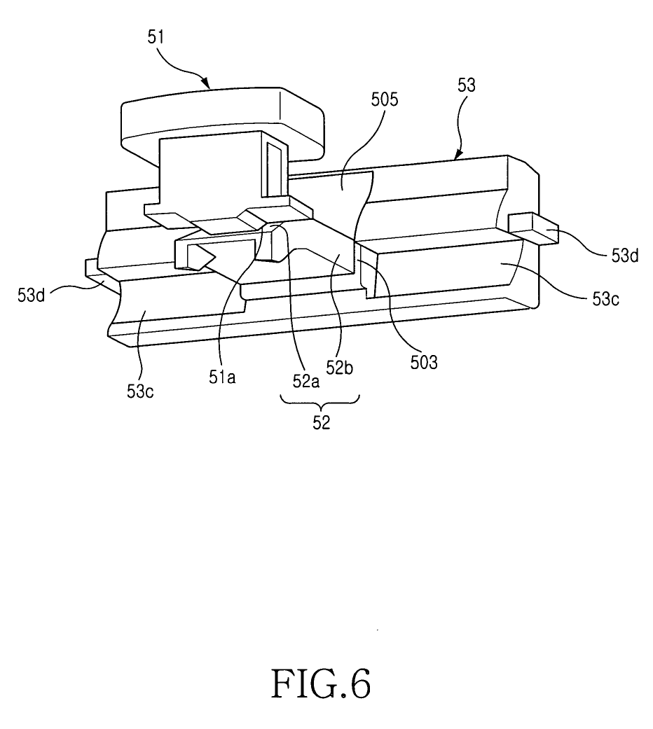

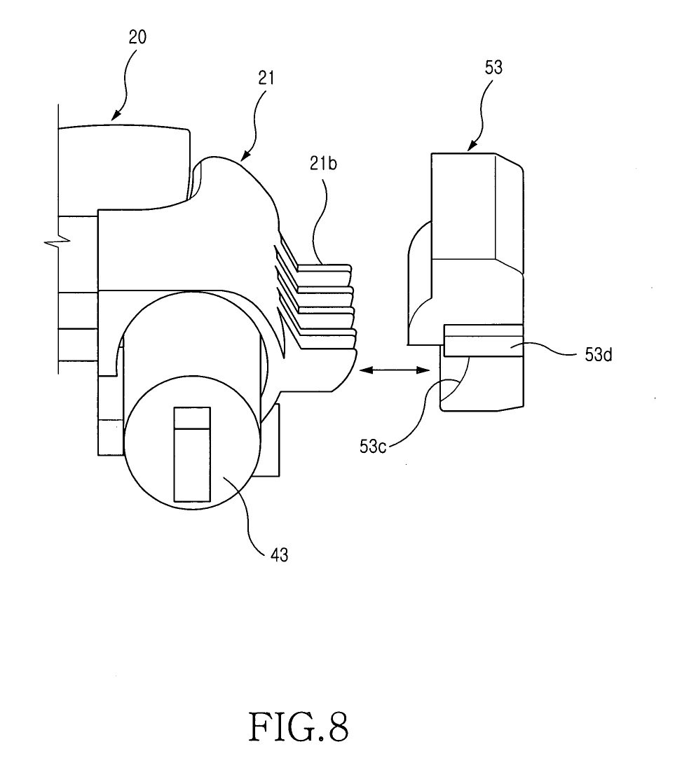

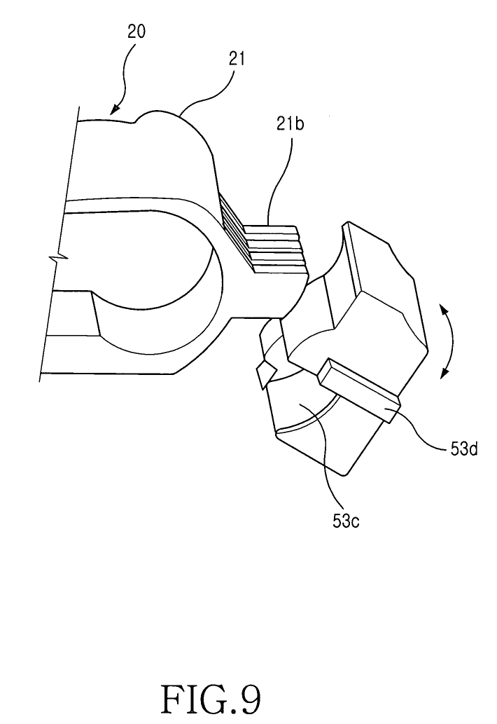

As shown in FIGS. 1 to 15, a portable communication apparatus 10 comprises first and second housings 10 and 20, a dual hinge device 40, and a hinge locking module 50.

The first housing 20 extends along a longitudinal direction and is rotatably connected to the dual hinge device 40.

The second housing 30 is connected to the first housing 20 by the dual hinge device 40 in such a manner that it can be rotated in multiple stages about first and second hinge axes A1 and A2 of the dual hinge device 40 toward or away from the first housing 20 in a direction perpendicular to the longitudinal direction.

The dual hinge device 40 rotatably connects the first and second housings 20 and 30 to each other, provides the first and second hinge axes A1 and A2, and is adapted to rotate the second housing 30 about the first hinge axis A1, as well as to extendedly rotate the second housing 30 about the second hinge axis A2 in such a manner that the second housing extends 30 along the longitudinal direction of the second housing 30 when a button unit 51, which is exposed to the exterior of the first housing 30, is pressed.

The hinge locking module 50 is positioned in the first housing 20 and the dual hinge device 40 in such a manner that the second housing 30 can be extendedly rotated or held as the button unit 51 is pressed.

The first and second housings 20 and 30 have respective first and second center hinge arms 21 and 31 protruding from their ends to be coupled to a pair of side hinge arms 41 and 42, which are formed on the opposite ends of the dual hinge device 40.

In addition, the dual hinge device 40 has pairs of first and second side hinge arms 41 and 42 which are formed on its upper and lower ends, respectively, while facing each other and are coupled to respective center hinge arms 21 and 31, which are formed on the center portion of the first and second housings 20 and 30, respectively.

The first housing 22 has a mounting hole 22 formed in a predetermined position so that the button unit 51 can be moved vertically therein.

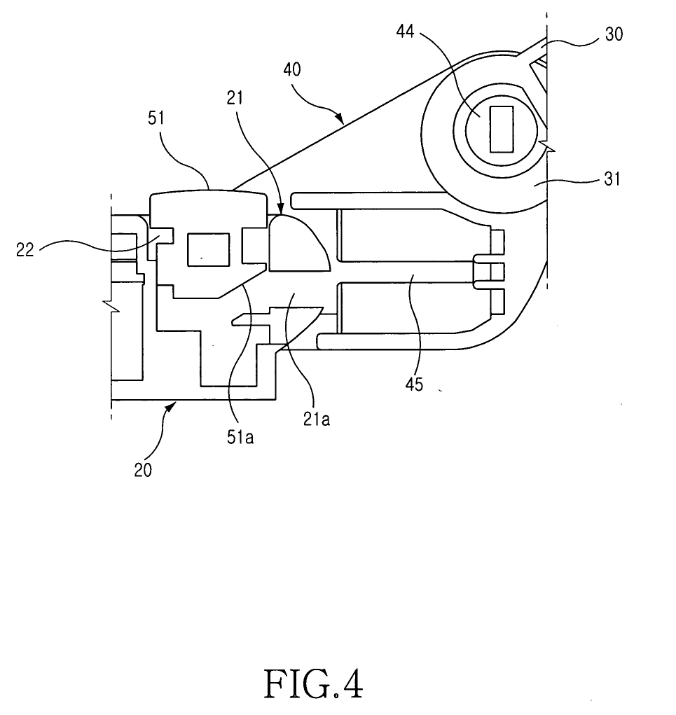

The first center hinge arm 21 has a guide hole 21a (see FIG. 4) formed on its center portion so that a locker unit 52, which is provided on the hinge locking module 50, extends through it and is guided to slide horizontally within it.

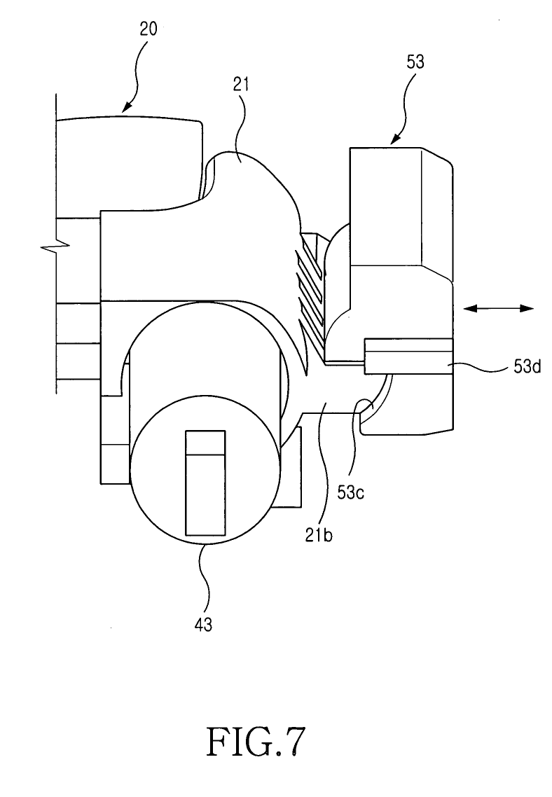

The first center hinge arm 21 has at least one releasable protrusion 21b (see FIG. 7) formed on its outer periphery, which protrudes along the longitudinal direction of the housing and is adapted to be coupled to and released from a locking unit 53, which is provided on the hinge locking module 50.

The first housing 20 is provided with a number of key buttons 23 and a microphone device 24.

The second housing 30 is provided with an LCD display unit 32 and a speaker device 33.

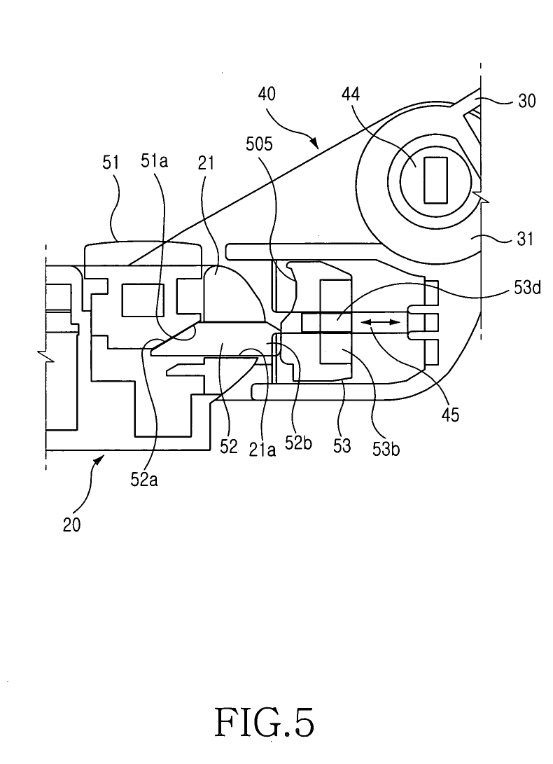

The first and second center hinge arms 21 and 31 have respective first and second hinge cams 43 (see FIG. 7) and 44 (see FIG. 5) positioned therein, which are rotatably coupled to the first and second side hinge arms 41 and 42 of the dual hinge device 40, respectively.

The hinge locking module 50 comprises a button unit 5 1, a locker unit 52, a locking unit 53, and a coil spring 54.

The button unit 51 is positioned in the mounting hole 22 of the first housing 20 in such it can be moved vertically therein by an external force.

The button unit 51 is exposed to the exterior from within the mounting hole 22.

The locker unit 52 extends through and is coupled to the guide hole 21 a in such a manner that it can be moved horizontally as the button unit 51 is moved vertically.

The locking unit 53 is positioned in a housing of the dual hinge device 40 in such a manner that it can be moved horizontally together with the locker unit 52, as the latter is moved horizontally, and it can be coupled to and released from the releasable protrusion 21b of the first center hinge arm 21 to extendedly rotate or hold the second housing 30.

The coil spring 54 is positioned on the rear surface of the locking unit 53 to provide a resilient force so that the locker unit 52 can be moved horizontally.

The button unit 51 has a button-side guide slant surface 51a formed on its lower portion, which corresponds to a protrusion-side guide slant surface 52a formed on the locker unit 52.

The locker unit 52 has a protrusion-side guide slant surface 52a formed on one end, which faces the button-side guide slant surface 51a and enables horizontal movement as the button unit 51 is moved vertically.

The locker unit 52 has a contact protrusion 52b formed on the other end, which is adapted to contact a contact surface 503 formed on the locking unit 53.

The locking unit 53 comprises a hinge stopper unit 53a, a spring coupler unit 53b, at least one coupling groove 53c, and a rail protrusion 53d.

The hinge stopper unit 53a is positioned on the front center portion of the locking unit 53 so that it can extendedly rotate or stop the second housing 30 as the locker unit 52 is moved horizontally.

The spring coupler unit 53b is positioned on the rear surface of the locking unit 53 so that it can be coupled to the coil spring 54 and support it at the same time.

The coupling groove 53c is formed on both sides of the hinge stopper unit 53a and is adapted to be coupled to and released from the releasable protrusion 21b as the locker unit 52 is moved horizontally.

The rail protrusion 53d is formed on both sides of the locking unit 53 in such a manner that it can be coupled to a rail groove 45, which is formed in the dual hinge device 40, to guide the horizontal sliding movement of the locking unit 53.

The hinge stopper unit 53a is provided with a contact surface 503 to contact the contact protrusion 52b of the locker unit 52.

The contact surface 503 has an engaging step 504 formed on its upper portion so that the contact protrusion 52b can be released from or engaged with the contact surface 503, as the contact protrusion 52b is moved horizontally.

The engaging step 504 has a guide groove 505 formed on its upper portion to guide the contact protrusion 52b, once the latter is released from the engaging step 504.

The guide groove 505 defines a curve which is concave toward the inside of the locking unit 53.

The dual hinge device 40 is adapted to rotate the second housing 30 up to 150° from the first housing 20 about the first hinge axis A1 and, if the button unit 51 of the hinge locking module 50 is pressed in this state, to extendedly rotate the second housing 30 to 180° about the second hinge axis A2.

The operation of a portable communication apparatus according to an embodiment of the present invention, configured as above, will now be described in detail with reference to FIGS. 1 to 15.

As shown in FIGS. 1 to 3, the portable communication apparatus 10 comprises first and second housings 10 and 20, a dual hinge device 40, and a hinge locking module 50.

If a user wants to use the apparatus 10 for speech communication, as shown in FIG. 1, the second housing 30 is rotated away from the first housing 20 in a direction perpendicular to a longitudinal direction.

The rotation is performed about a first hinge axis A1 of the dual hinge device 40.

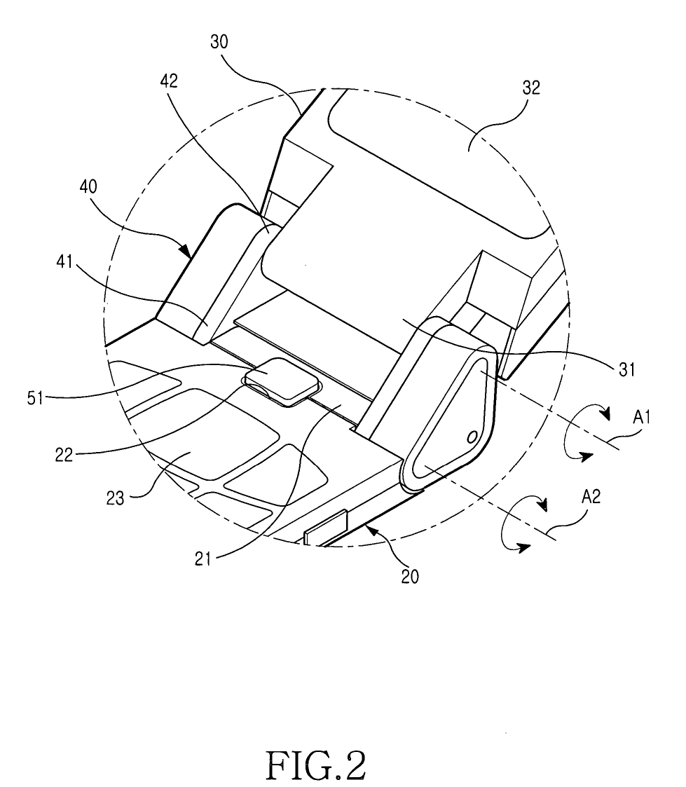

As shown in FIG. 2, the dual hinge device 40 has a pair of second side hinge arms 42 which are formed on the opposite upper ends thereof, while facing each other, and are coupled to a second center hinge arm 31, which is formed on the center portion of the second housing 30. The second center hinge arm 31 is rotatably coupled to the second side hinge arm 42. The second housing 30 is then rotated from the second housing 20 by the second side hinge arm 42 and the second center hinge arm 31.

The second housing 30 is rotated up to 150° from the first housing 20 and is stopped.

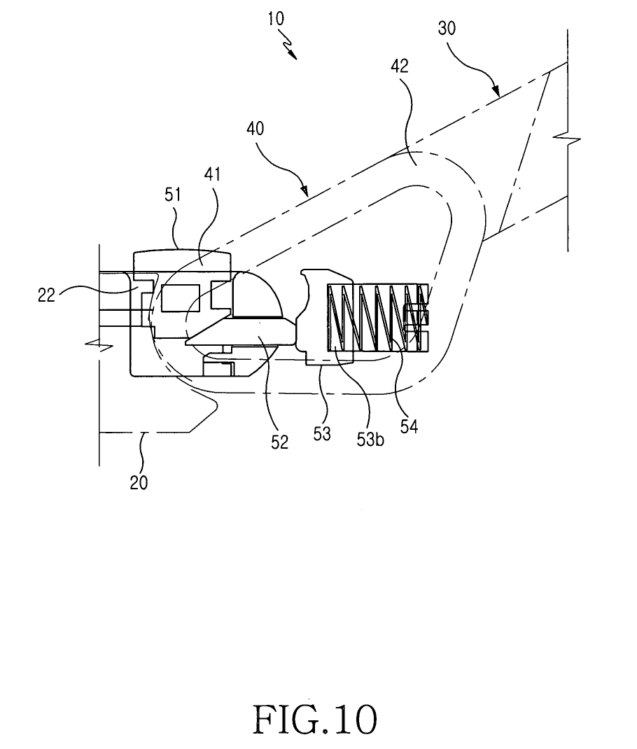

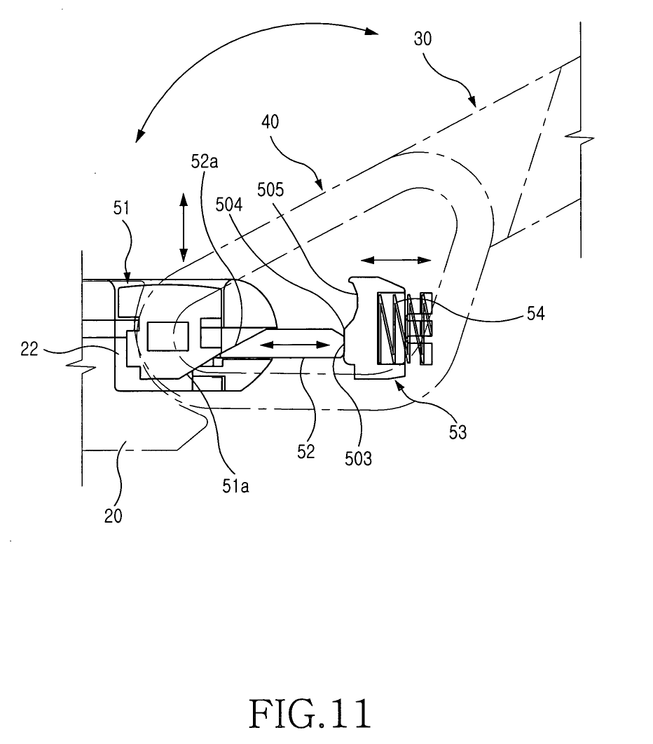

If a user wants to watch a video clip, as shown in FIG. 10, using an LCD display unit 32 which is positioned on the second housing 30 of the apparatus 10, the user presses a button unit 51 which is positioned in a mounting hole 22 of the first housing 20. The button unit 51 is then moved downward as shown in FIG. 11.

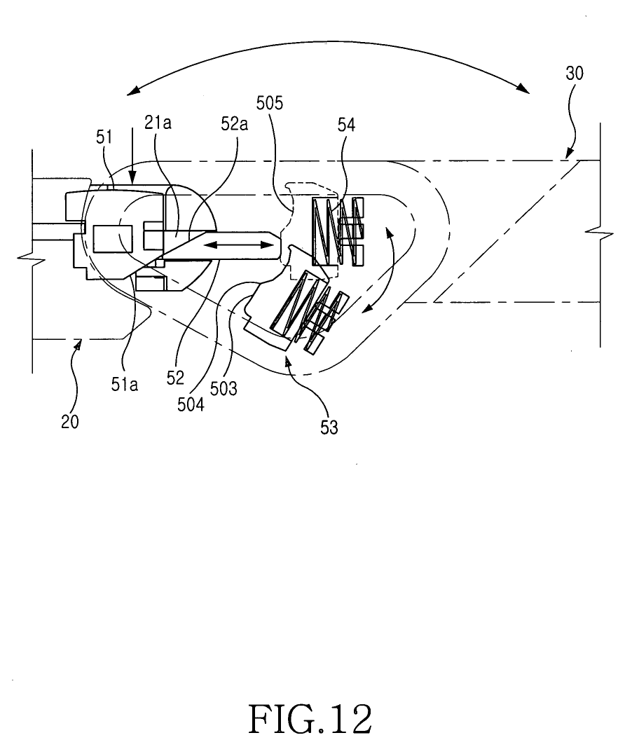

As shown in FIGS. 11 and 12, the button unit 51 has a button-side guide slant surface 5 la formed on its lower portion, which corresponds to a protrusion-side guide slant surface 52a formed on the locker unit 52. If the button-side guide slant surface 51a is moved downward, the protrusion-side guide slant surface 52a is moved rightward.

As shown in FIG. 12, the locker unit 52 extends through and is coupled to a guide hole 21a, which is formed on the center portion of the first center hinge arm 21. If the protrusion-side guide slant surface 52a is moved horizontally by the button-side guide slant surface 51 a, the locker unit 52 is slid rightward in the guide hole 21a.

The locker unit 52 has a contact protrusion 52b which is adapted to contact a contact surface 503 formed on the locking unit 53. As the locker unit 52 is slid, the contact protrusion 52b is moved together with the contact surface 503 of the locking unit 53, while being forced against it.

As shown in FIGS. 4 and 5, the locking unit 53 has a rail protrusion 53d formed on both sides thereof in such a manner that it can be coupled to a rail groove 45, which is formed in the dual hinge device 40, to guide the horizontal sliding movement of the locking unit 53.

As shown in FIGS. 7 to 9, a releasable protrusion 21b, which is formed on the outer periphery of the first center hinge arm 21, is then released from a coupling groove 53c of the locking unit 53.

As shown in FIG. 12, the contact surface 503 has an engaging step 504 formed on its upper portion so that the contact protrusion 52b, which is formed on the locker unit 52, can be released from or engaged with the contact surface 503, as the contact protrusion 52b is moved horizontally. The contact protrusion 52b of the locker unit 52 is then released from the engaging step 504, and the engagement is ended.

As shown in FIGS. 11 and 12, the engaging step 504 has a guide groove 505 formed on its upper portion to guide the second housing 30 in such a manner that it can be extendedly rotated, once the contact protrusion 52b is released from the engaging step 504. As the locking unit 53 of the second housing 30 is extendedly rotated, the contact protrusion 52b is moved to the guide groove 505.

As shown in FIG. 12, the guide groove 505 defines a curve which is concave toward the inside of the locking unit 53 and guides the contact protrusion 52b along the curve.

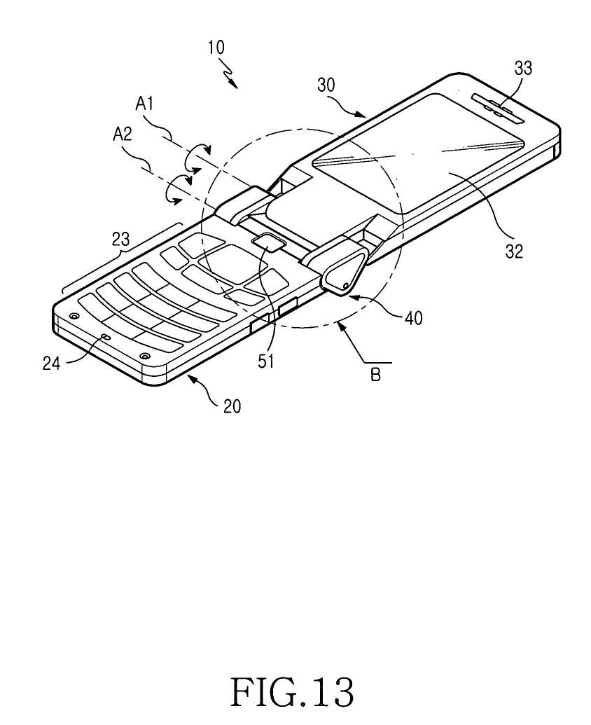

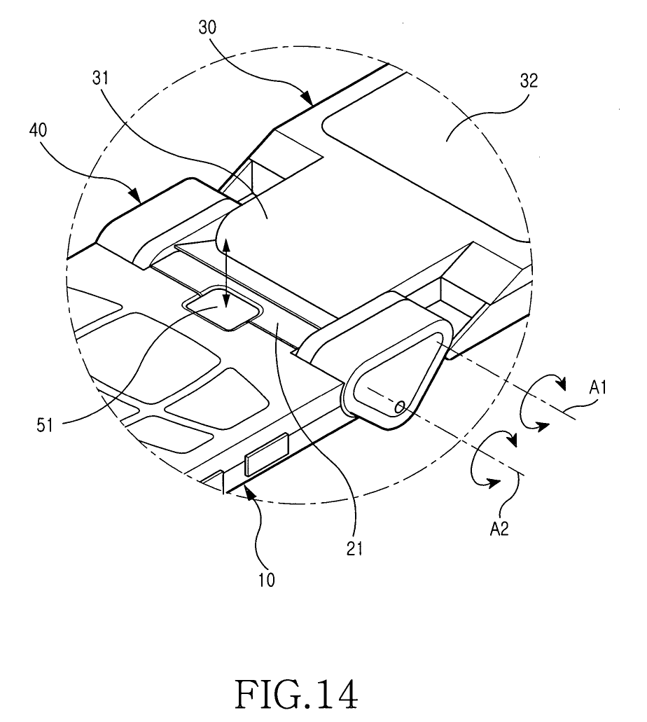

As shown in FIGS. 13 and 14, the locking unit 53 is extendedly rotated about the second hinge axis A2 of the dual hinge device 40, and the second housing 30 is rotated accordingly.

As shown in FIG. 13, the dual hinge device 40 has a pair of first side hinge arms 41 which are formed on the opposite lower ends thereof, while facing each other, and are coupled to a first center hinge arm 21, which is formed on the center portion of the first housing 20. As such, the second housing 30 is extendedly rotated from the first housing 20 by the first side hinge arm 41 and the first center hinge arm 21.

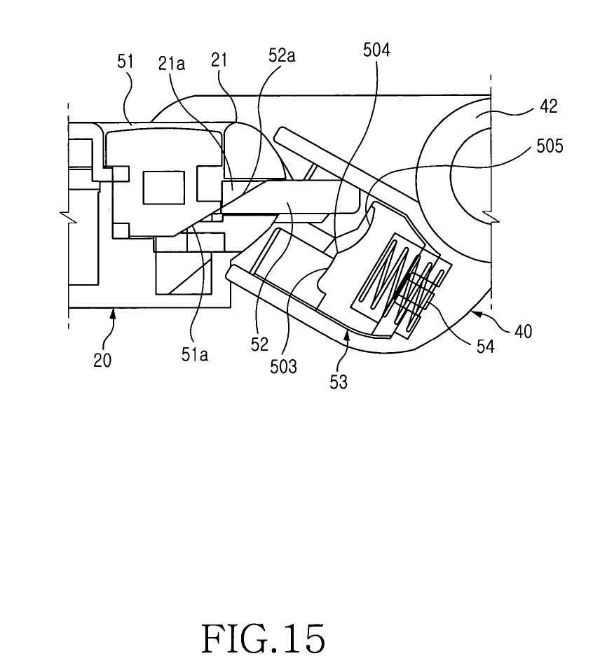

As shown in FIGS. 13 and 15, the second housing 30 is extendedly rotated up to 180° from the first housing 20.

If a user wants to use the apparatus 10 for speech function again, the second housing 30 is rotated toward the first housing 20, as shown in FIGS. 10 and 11. The contact protrusion 52b of the locker unit 52 is then reversely rotated along the guide groove of the locking unit 53 and contacts the contact surface 503.

The locking unit 53 has a coil spring 54 positioned on its rear surface to provide a resilient force so that the locker unit 52 can be moved horizontally. As such, the locking unit 53 is moved leftward due to the resilient force from the coil spring 54.

The locker unit 52 is then moved together, as shown in FIGS. 10 and 11. The protrusion-side guide slant surface 52a, which is formed on the locker unit 52, corresponds to the button-side guide slant surface 51a. If the protrusion-side guide slant surface 52a is moved horizontally, the button-side guide slant surface 51a moves the button unit 51 upward and causes it to be exposed to the exterior through the mounting hole 22.

The apparatus 10 is then ready to use for performing a speech function.

If the apparatus 10 is not used, the second housing 30 is rotated toward the first housing 20 about the first hinge axis A1 of the dual hinge device 40 and is folded on the first housing 20 to be closed.

As mentioned above, the portable communication apparatus can be extendedly rotated from an angular position, wherein it is opened for speech, so that it can be used as a remote control unit and for other additional functions in a convenient way.

While the invention has been shown and described with reference to certain embodiments thereof, it should be understood by those skilled in the art that various changes in form and details may be made therein without departing from the spirit and scope of the invention as defined by the appended claims.

1. A portable communication apparatus comprising:
a first housing extending along a longitudinal direction;
a second housing connected to the first housing by a dual hinge device and adapted to be rotated in multi-stages toward or away from the first housing about first and second hinge axes in a direction perpendicular to the longitudinal direction;
a dual hinge device which rotatably connects the first and second housing to each other, provides the first and second hinge axes, and is adapted to rotate the second housing about the first hinge axis, as well as to rotate the second housing about the second hinge axis in such a manner that the second housing extends along the longitudinal direction of the second housing when a button unit, which is exposed to an exterior of the first housing, is pressed; and
a hinge locking module positioned in the first housing and the dual hinge device to extendedly rotate or hold the second housing as the button unit is pressed.

2. A portable communication apparatus as claimed in claim 1, wherein the first and second housings have respective first and second center hinge arms protruding from their ends for coupling to a pair of side hinge arms, which are formed on the opposite ends of the dual hinge device.

3. A portable communication apparatus as claimed in claim 1, wherein the dual hinge device has pairs of first and second side hinge arms which are formed on its upper and lower ends, respectively, while facing each other and are coupled to respective center hinge arms, which are formed on the center portion of the first and second housings, respectively.

4. A portable communication apparatus as claimed in claim 1, wherein the first housing has a mounting hole formed in a predetermined position to contain the button unit therein.

5. A portable communication apparatus as claimed in claim 2, wherein the first center hinge arm has a guide hole formed on its center portion so that a locker unit, which is provided on the hinge locking module, extends through it and is guided to slide horizontally and at least one releasable protrusion formed on its outer periphery, which protrudes along the longitudinal direction of the housing and is adapted to be coupled to and released from a locking unit, which is provided on the hinge locking module.

6. A portable communication apparatus as claimed in claim 1, wherein the first housing is provided with a number of key buttons and a microphone device.

7. A portable communication apparatus as claimed in claim 1, wherein the second housing is provided with a Liquid Crystal Display (LCD) display unit and a speaker device.

8. A portable communication apparatus as claimed in claim 2, wherein the first and second center hinge arms have respective first and second hinge cams positioned therein, which are adapted to be rotatably coupled to the respective first and second side hinge arms of the dual hinge device.

9. A portable communication apparatus as claimed in claim 1, wherein the hinge locking module comprises:
a button unit which is exposed to the exterior from within the mounting hole of the first housing and is adapted to be moved vertically by an external force;
a locker unit which extends through and is coupled to the guide hole and is adapted to be moved horizontally as the button unit is moved vertically;
a locking unit which is positioned in a housing of the dual hinge device and is adapted to be coupled to and released from the releasable protrusion of the first center hinge arm, as the locker unit is moved horizontally, to extendedly rotate or hold the second housing; and
a coil spring which is positioned on the rear surface of the locking unit and provides a resilient force so that the locker unit can be moved horizontally.

10. A portable communication apparatus as claimed in claim 9, wherein the button unit has a button-side guide slant surface formed on its lower portion, which corresponds to a protrusion-side guide slant surface formed on the locker unit.

11. A portable communication apparatus as claimed in claim 9, wherein the locker unit has a protrusion-side guide slant surface formed on one end, which faces the button-side guide slant surface and enables a horizontal movement as the button unit is moved vertically, and a contact protrusion formed on the other end, which is adapted to contact a contact surface formed on the locking unit.

12. A portable communication apparatus as claimed in claim 9, wherein the locking unit is composed of:
a hinge stopper unit which is positioned on the frontal center portion of the locking unit and is adapted to extendedly rotate or stop the second housing as the locker unit is moved horizontally;
a spring coupler unit which is positioned on the rear surface of the locking unit and is adapted to be coupled to the coil spring and support it at the same time;
at least one coupling groove which is formed on both sides of the hinge stopper unit and is adapted to be coupled to and released from the releasable protrusion as the locker unit is moved horizontally; and
a rail protrusion which is formed on both sides of the locking unit and is adapted to be coupled to a rail groove, which is formed in the dual hinge device, and to guide the horizontal sliding movement of the locking unit.

13. A portable communication apparatus as claimed in claim 12, wherein the hinge stopper unit is provided with a contact surface to contact the contact protrusion of the locker unit, the contact surface has an engaging step formed on its upper portion so that the contact protrusion can be released from or engaged with the contact surface, as the contact protrusion is moved horizontally, and the engaging step has a guide groove formed on its upper portion to guide the contact protrusion, once the latter is released from the engaging step, so that the second housing can be extendedly rotated.

14. A portable communication apparatus as claimed in claim 13, wherein the guide groove defines a curve which is concave toward the inside of the locking unit.

15. A portable communication apparatus as claimed in claim 1, wherein the dual hinge device is adapted to rotate the second housing up to about 150° from the first housing about the first hinge axis of the dual hinge device and, if the button unit of the hinge locking module is pressed in this state, extendedly rotate the second housing to about 180° about the second hinge axis of the dual hinge device.

16. A method for rotating a portable communication apparatus in multiple stages:
extending a first housing along a longitudinal direction;
rotating a second housing connected to the first housing by a dual hinge device in multi-stages toward or away from the first housing about first and second hinge axes in a direction perpendicular to the longitudinal direction;
rotably connecting a dual hinge device to the first and second housing, providing the first and second hinge axes for rotating the second housing about the first hinge axis and rotating the second housing about the second hinge axis in such a manner that the second housing extends along the longitudinal direction of the second housing when a button unit, which is exposed to an exterior of the first housing, is pressed; and
extendedly rotating or holding the second housing as the button unit is pressed via a hinge locking module positioned in the first housing and the dual hinge device.

17. A method as claimed in claim 16, further comprising:
providing the first and second housings with respective first and second center hinge arms protruding from their ends for coupling to a pair of side hinge arms, which are formed on the opposite ends of the dual hinge device.

18. A method as claimed in claim 16, wherein the dual hinge device has pairs of first and second side hinge arms which are formed on its upper and lower ends, respectively, while facing each other and are coupled to respective center hinge arms, which are formed on the center portion of the first and second housings, respectively.

19. A method as claimed in claim 16, further comprising:
forming a mounting hole in the first housing in a predetermined position to contain the button unit therein.

20. A method as claimed in claim 17, further comprising:
forming a guide hole in the first center hinge arm on its center portion so that a locker unit, which is provided on the hinge locking module, extends through it and is guided to slide horizontally; and
providing at least one releasable protrusion formed on an outer periphery of the first center hinge arm, which protrudes along the longitudinal direction of the housing and is adapted to be coupled to and released from a locking unit, which is provided on the hinge locking module.

21. A method as claimed in claim 16, further comprising:
providing the first housing with a number of key buttons and a microphone device.

22. A method as claimed in claim 16, further comprising:
providing the second housing with a Liquid Crystal Display (LCD) display unit and a speaker device.
